(19) United States
(12) Patent Application Publication
(10) Pub. No.: US 2006/0183045 A1
(43) Pub. Date: Aug. 17, 2006

(54) Developing agent and process for producing the same

(76) Inventors: Shinichi Nakano, Nara (JP); Yasuhiro Shibai, Nara (JP); Keiichi Kikawa, Osaka (JP)

Correspondence Address: BIRCH STEWART KOLASCH & BIRCH, PO BOX 747, FALLS CHURCH, VA, 22040-0747, US

(21) Appl. No.: 10/544,455

(22) PCT Filed: Jan. 23, 2004
(86) PCT No.: PCT/JP04/00609

§ 371 Date: Aug. 4, 2005

(30) Foreign Application Priority Data
Feb. 5, 2003 (JP) 2003-028393

(51) Int. Cl. G03G 9/08

(52) U.S. Cl. 430/105; 430/137.1

(57) ABSTRACT

A method for manufacturing a developing agent comprising dissolving a binder resin component in a supercritical fluid or a subcritical fluid, mixing it with a colorant component, reducing the solubility of the binder resin component in the supercritical fluid or subcritical fluid, and causing the binder resin component to be deposited in the form of particles while the colorant component is dispersed within the binder resin component. After the pressure within a reaction vessel is decreased from A (MPa) to B (MPa) (where A>B>critical pressure) following the manufacture of a developing agent, the method proceeds back to a developing agent manufacturing step again when at least a developing agent material and a supercritical fluid or a subcritical fluid are injected into the reaction vessel under high pressure. The method allows the dispersibility of the colorant component in the developing agent to be increased up to a primary particle level, whereby a developing agent with an even particle shape and a narrow particle size distribution can be obtained. The method also makes continuous production possible without the need to open and close the reaction vessel, leading to a high production efficiency.

### TECHNICAL FIELD

The present invention relates to a developing agent for developing an electrostatic latent image formed on an image carrier by an electrophotographic process or an ion flow process, and to a method for manufacturing the developing agent.

### BACKGROUND ART

In image forming devices based on electrophotographic process, such as laser printers, LED (light-emitting diode) printers, or digital copiers, the surface of a photosensitive material is uniformly charged, and a desired electrostatic latent image is formed thereon by irradiating the surface with light, such as a laser beam or light emitted by an LED, in accordance with image information. The thus formed electrostatic latent image is then visualized with the use of a developing agent in a developing unit, thereby forming a visual image that is fixed on a recording material.

Recent years have seen an increasing demand for smaller-sized image forming devices. When attempting to reduce size in the image-forming devices based on the electrophotographic process, it is important to consider the area occupied by the developing agent, which is fairly large. Particularly, in the modern network environments where a number of people share a single image-forming device that produces a large volume of print output, it is necessary to store a large volume of developing agent if the users' ease of use is to be considered.

There is also a growing demand for color image output, which requires a color image-forming device that uses three or four color developing agents. In this case, the volume occupied by the developing agents in the image-forming device becomes even larger. Furthermore, in the case of color images, color reproduction is based on superposition of multiple colors, resulting in an increase in the amount of developing agent on the recording medium (such as paper or an OHP sheet). This means that a greater amount of heat is required for thermally fixing the developing agent than in the case of monochromatic images, leading to an increase in the size of the fixing unit.

Regarding the process for manufacturing developing agents, more energy-efficient and more environmentally friendly processes are required. The current major processes for manufacturing developing agent can be largely divided into the melting, kneading and pulverizing process, which is a conventional process, and the more recent processes involving polymerization in a liquid solvent (such as the suspension process, emulsification process, and dispersion process, for example).

For example, a developing agent used in a dry developing process consists of thermoplastic resin (binder resin), pigment (colorant), and mold-releasing agent as principal components, to which magnetic powder, charge control agent, or flow improver, for example, are further added as required. A typical process for manufacturing such developing agent generally consists of mixing the raw materials at once, heating, melting, and dispersing the mixture in a mixer, thereby producing a uniform composition. The composition is then cooled, pulverized, and classified into a developing agent with a volume-average particle diameter of approximately 10 μm.

Particularly, the electrophotographic color developing agents used for the formation of color images typically consist of a binder resin in which a variety of chromatic color pigments are dispersed. In this case, the developing agent used is required to perform much better than the developing agent used for obtaining black image. Specifically, the color developing agents must be more stable both mechanically and electrically against external factors, such as shock or humidity. They are also required to produce correct chromatic expressions (color development) and provide sufficient optical transmissivity (transparency) when used with an overhead projector (OHP).

An example of the use of pigments as a colorant is described in JP Patent Publication (Kokai) No. 49-46951 A (1974). Although pigment-based color developing agents are superior in light resistance, they have poor pigment dispersibility against the binder resin and are therefore inferior in terms of coloration (color development) or transparency due to the poor dispersibility against binder resin.

Various methods for improving the dispersibility of pigment against binder resin have been proposed, including the following:

(1) JP Patent Publication (Kokai) No. 62-280755 A (1987) discloses a technique involving a polyester resin (resin A) as a binder resin, whereby a pigment is coated in advance with a polyester resin (resin B) with a greater molecular weight than resin A, and the thus coated resin is dispersed in resin A to obtain a color developing agent.

(2) JP Patent Publication (Kokai) No. 2-66561 A (1990) discloses a color developing agent comprising a binder resin in which a processed pigment obtained by melting and kneading a resin and a pigment resin is dispersed. The weight-average molecular weight of the pigment resin is smaller than the weight-average molecular weight of the binder resin, and the weight-average molecular weight of the binder resin is 100,000 or greater.

(3) JP Patent Publication (Kokai) No. 9-101632 A (1997) discloses a technique whereby a mixture of a binder resin and pigment is kneaded with an organic solvent in a first stage at a temperature lower than the melting temperature of the binder resin. A second-stage heating, melting and kneading is then conducted by further adding binder resin and charge control agent to obtain a color developing agent.

(4) JP Patent Publication (Kokai) No. 2000-81736 A discloses a pigment for developing agents in which a low-molecular substance is absorbed. The low-molecular substance has a melting point lower than that of binder resin, which is a principal component of the developing agent, and has a low melt viscosity. The oil absorption amount of the low molecular weight substance is 50 g (per 100 g of pigment) or more, and the oil absorption ratio of the low-molecular weight substance with respect to the pigment is 100% to 300% of the saturation absorption oil amount. The melt viscosity of the low-molecular weight substance at the melting point +20° C. is 0.1 Pa·s or lower. The publication also discloses a method of pre-processing the developing agent pigment, a developing agent using the pigment, and a method of manufacturing a developing agent.

However, none of these prior art methods according to Patent Documents 2 to 5 are capable of providing a sufficient degree of dispersion of pigment, with the resultant poor coloration and transparency. In the case of black developing agents for monochromatic purposes, normally 7 to 15 parts by weight of carbon is used as a black colorant. Generally, prior to kneading, a carbon powder is mixed with other materials, and then the mixture is melted and kneaded. In this case, since black developing agents, as opposed to color developing agents, are not required to have transparency, the degree of coloration can be increased by simply increasing the amount of carbon used. However, an increase in the amount of carbon, which is electrically conductive, means a reduction of the volume resistivity value of the developing agent, which is not desirable from the viewpoint of charge amount stability. Therefore, carbon must be sufficiently dispersed so that a high volume resistivity value of the developing agent can be obtained.

As a method for improving the dispersibility of carbon, the aforementioned two-stage kneading for color developing agent is not suitable, because it would lead to an increase in cost. Instead, in a conventional method (5), the processed amount during kneading is reduced. Other methods include a method (6) whereby the temperature of resin during kneading is lowered, and another method (7) wherein a rolling and cooling method after kneading is specified. These methods (5), (6), and (7), however, have the disadvantage of increased cost due to the reduction in processed amount.

### DISCLOSURE OF THE INVENTION

JP Patent Publication (Kokai) No. 2001-31209 A discloses a developing agent and a technique for the manufacture thereof, involving a supercritical fluid or subcritical fluid for increasing the content of colorant in the developing agent while the dispersibility of the colorant is maintained. This technique is capable of achieving desired image quality with only a small amount of developing agent and reducing energy consumption. However, with the technique disclosed in JP Patent Publication (Kokai) No. 2001-31209 A, it has been difficult to achieve dispersion of the colorant in the developing agent to the primary particle level.

JP Patent Publication (Kokai) No. 6-126102 A (1994) discloses a method for manufacturing fine particles by dissolving a solute in a high-pressure and high-temperature solvent and then reducing the pressure, thereby achieving a supersaturated state in which the solute is deposited. In this method, after the solute is dissolved with a pressure P2 which is greater than a pressure P1 at the start of pressure reduction, the pressure is brought back to near P1, where it is maintained for a certain time. This is followed by a reduction in pressure to dissolve fine particles. With this technique, however, it has been difficult to achieve a uniform shape of the fine particles.

It is therefore an object of the invention to provide a method for manufacturing a developing agent with an improved production efficiency whereby the dispersibility of a colorant in a developing agent can be increased to the primary particle level, whereby a developing agent with uniform particle shape and a narrow particle distribution can be obtained, and whereby production can be continuously performed without opening and closing reaction vessels.

The inventors realized that the above objective could be achieved by performing appropriate maneuvers in a method for manufacturing toner involving a supercritical fluid or subcritical fluid.

In one aspect, the invention provides a method for manufacturing a developing agent for electrostatic charge development, comprising dissolving a binder resin component in a supercritical fluid or subcritical fluid, mixing it with a colorant component, reducing the solubility of said binder resin component in said supercritical fluid or said subcritical fluid, and causing said binder resin component to be deposited in the form of particles while said colorant component is dispersed inside said binder resin component, said method further comprising reducing the pressure inside a reaction vessel from A (MPa) to B (MPa) (A>B>critical pressure) after a developing agent has been produced, and then, when proceeding back to the developing agent manufacturing process again, at least a developing agent material and a supercritical fluid or subcritical fluid are injected into said reaction vessel under high pressure.

The invention is based on the technology for preparing a developing agent by dissolving a binder resin component in a supercritical fluid or a subcritical fluid, mixing it with a colorant component, reducing the solubility of the binding resin component, and then causing the binding resin component to be deposited in the form of particles, wherein the colorant component is dispersed in the binder resin component. Thus, in this process, the binding resin component is dissolved in a supercritical fluid or subcritical fluid without feeding appropriate developing agent materials, the binding resin component is mixed with a colorant component, the solubility of the binding resin component in the supercritical fluid or subcritical fluid is reduced, and the binding resin component is caused to be deposited in the form of particles while the colorant component is dispersed within the binding resin component. The resultant developing agent, however, could have an uneven composition. For instance, the developing agent might contain excessive resin component, or it might contain too little resin component. Thus, it is necessary to feed the developing agent components in even amounts.

In contrast, the invention provides the following advantageous effects.

Namely, after the pressure inside a reaction vessel is reduced from A (MPa) to B (MPa) (A>B>critical pressure), a supercritical fluid or subcritical fluid is added once again and the pressure inside the reaction vessel is increased to near A (MPa), when at least developing agent materials and a supercritical fluid or subcritical fluid are injected into the reaction vessel under high pressure. In this way, a developing agent with a narrow particle size distribution can be produced in a continuous manner without having to open and close the reaction vessel. Thus, the invention provides a highly efficient method for manufacturing a developing agent.

Preferably, when the process proceeds back to a power producing step, the developing agent materials are dissolved in a supercritical fluid in advance before they are injected into a high-pressure cell. Specifically, after the pressure inside the reaction vessel is reduced from A (MPa) to B (MPa), a supercritical fluid or a subcritical fluid is put into the reaction vessel once again so as to increase the pressure therein, where the developing agent materials are dissolved in the supercritical fluid in advance, before the developing agent materials are injected into the high-pressure cell. In this way, components of the developing agent materials that have not been dissolved can be prevented from being put into the high-pressure cell. At the same time, the rate of dissolution of the developing agent materials in the supercritical fluid or subcritical fluid can be greatly increased. Thus, a highly efficient method for manufacturing a developing agent can be provided.

Preferably, when the method proceeds back to the powder manufacturing step, the developing agent materials are melted by heat before they are injected into the high-pressure cell. Specifically, after the pressure inside the reaction vessel is reduced from A (MPa) to B (MPa), a supercritical fluid or subcritical fluid is added into the reaction vessel again so as to increase the pressure therein, where the developing agent materials are melted by heat in advance. In this way, the rate of dissolution of the developing agent materials can be greatly increased, and a highly efficient method for manufacturing a developing agent can be provided.

Preferably, when the method proceeds back to the powder manufacturing step, an entrainer is further added. Specifically, after the pressure inside the reaction vessel is reduced from A (MPa) to B (MPa), a supercritical fluid or subcritical fluid is put into the reaction vessel again and the pressure therein is increased, when the entrainer is also added. In this way, the solubility of the developing agent materials with respect to the supercritical fluid or subcritical fluid can be greatly increased, whereby a highly efficient method for manufacturing a developing agent can be provided.

In another aspect, the invention provides a developing agent for electrostatic charge development produced by any of the aforementioned manufacturing methods.

### BRIEF DESCRIPTION OF THE DRAWINGS

FIG. 1 schematically shows a developing agent manufacturing apparatus used for manufacturing a developing agent according to the invention.

FIG. 2 schematically shows another developing agent manufacturing apparatus used for manufacturing a developing agent according to the invention.

FIG. 3 schematically shows another developing agent manufacturing apparatus used for manufacturing a developing agent according to the invention.

FIG. 4 shows a graph comparing the particle size distribution of a developing agent according to the invention and that of a developing agent according to a pulverizing process.

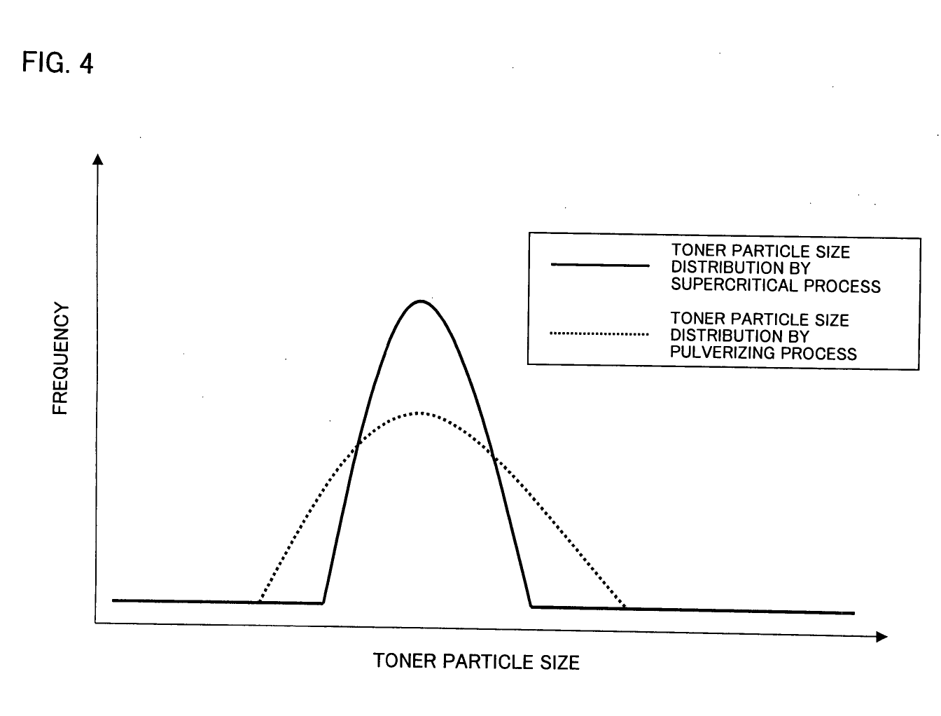

FIG. 5 schematically shows the TEM observation results of the developing agent shown in Example 5 of the invention. FIG. 5(a) pertains to the manufacture of a developing agent by a pulverizing process. FIG. 5(b) pertains to the manufacture of a developing agent by a supercritical process.

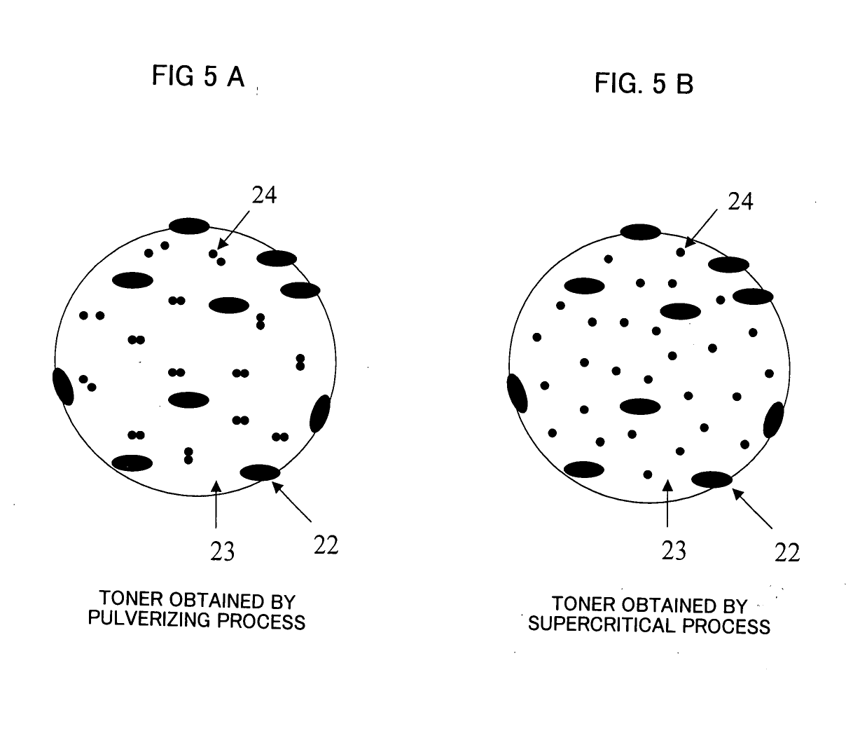

### BEST MODE FOR CARRYING OUT THE INVENTION

In accordance with a method of the invention, a binder resin component is dissolved in a supercritical fluid or subcritical fluid and then mixed with a colorant component. The solubility of the binder resin component in the supercritical fluid or subcritical fluid is reduced, and the binder resin component is deposited in the form of particles while the colorant component is dispersed inside the binding resin component.

When the temperature and pressure of a substance are set to be in certain conditions (critical point) or above, a fluid is obtained in which the density of gas phase and that of liquid phase are equal. The fluid at temperature and pressure above the vicinity of the critical point is referred to as a supercritical fluid. Even below the super-critical point, if the conditions are close to those of the critical point, the fluid would be in a state close to that of a supercritical fluid and such fluid is referred to as a subcritical fluid.

In a supercritical fluid and a subcritical fluid (in the following description of supercritical fluid, the term “supercritical fluid” includes subcritical fluid unless otherwise noted), the properties of gas and those of liquid appear together. For example, a supercritical fluid can be created that has a density which is close to that of liquid (several hundreds of times that of gas), a viscosity which is close to that of gas ( 1/10 to 1/100 that of liquid), a diffusion coefficient which is on the order of 1/10 to 1/100 that of liquid, and a thermal conductivity which is close to that of liquid (approximately 100 times that of gas).

Supercritical fluids generally have greater power to dissolve matter, with the matter-dissolving power being greatly variable depending on changes in temperature or pressure. This property makes supercritical fluids an outstanding solvent for reaction or extraction purposes. In fact, relevant studies are being done actively in recent years in the field of separation, extraction, or purification of substances. For instance, the studies involve extraction of caffeine in coffee, and separation or extraction of waste material.

Solubility of a solute in a supercritical fluid can be significantly reduced by dissolving a desired substance in the supercritical fluid and then rapidly expanding the fluid (RESS (Rapid Expansion of Supercritical Solution) process), or by adding a poor solvent or surfactant in the fluid. Manufacture of fine particles using this property, whereby substance dissolved in the fluid can be deposited, is also underway.

A method for manufacturing fine particles using a supercritical fluid is disclosed in JP Patent Publication (Kokai) No. 10-133417 A (1998), for example. This method, however, merely relates to the manufacture of fine particles to be externally added to developing agent, and the publication does not teach anything about methods for manufacturing a developing agent per se.

The present inventors focused on the aforementioned property of supercritical fluid and attempted to apply it to the manufacture of developing agent. As mentioned above, when trying to achieve reduction in size of image forming apparatuses of the electrophotographic type in which a developing agent is utilized, it is important to increase the color development of the developing agent. When increasing the amount of colorant in a developing agent for this purpose, the dispersibility of the colorant component in the developing agent must be improved. In a process involving a system for feeding developing agent materials after pressure reduction, when a colorant component and the binder resin component of the developing agent are mixed with a supercritical fluid in a reaction vessel, the dissolved substance (colorant component) and the mixed substance (colorant component of fine particles) can be evenly dispersed without their being flocculated, due to the aforementioned properties of supercritical fluid or subcritical fluid, namely, their ability to dissolve matter well and their large diffusion coefficient. In this way, the colorant component can be well dispersed in a supercritical fluid.

Thereafter, by reducing the pressure of the supercritical fluid in the reaction vessel, for example, the solute component that had been dissolved can be deposited. If the solubility of the solute in the supercritical fluid is rapidly decreased by a method such as the RESS process, the binder resin component that had been dissolved can be deposited in the form of fine particles. Since the pigment is dispersed in the supercritical fluid in a good condition, a developing agent can be obtained in the form of fine particles in which the colorant component is evenly dispersed in the fine particles of the binder resin component.

Examples of the supercritical fluid that can be used include CO₂, N₂, CH₄, C₂H₆, CF₃H, NH₃, CF₃Cl, CH₃OH, C₂H₅OH, and H₂0, for example.

The binder resin component may be any resin that can be used for developing agent. Examples include styrene resins, such as polystyrene, styrene/butadiene copolymer, and styrene/acrylic copolymer; ethylene resins, such as polyethylene, polyethylene/vinyl acetate copolymer, and polyethylene/vinyl alcohol copolymer; acrylic resins such as polymethyl methacrylate; phenol resins; epoxy resins; allyl phthalate resin; polyamide resin; polyester resin; and maleic acid resin. The weight-average molecular weight of the binder resin component is preferably in the range of 1×10³ to 1×10⁶.

The aforementioned colorant component includes organic pigment and inorganic pigment. Examples include carbon black, aniline blue, chalco-oil blue, chrome yellow, ultramarine yellow, methylene blue, DuPont oil red, quinoline yellow, methylene blue chloride, phthalocyanine blue, rose bengal, disazo yellow, carmine 6B, and quinacridone pigment. The particle diameter (primary particle) of the aforementioned pigments is in the range of 40 nm to 400 nm and preferably 100 nm to 200 nm.

In addition to the binder resin component and the colorant component that are mixed with the supercritical fluid, an entrainer may be added for increasing the affinity between the supercritical fluid or subcritical fluid and solute.

The entrainer is selected in view of the substance of the supercritical fluid used and the solute that is mixed. Examples include alcohols (such as methanol, ethanol, isopropanol, or butanol), ketones (such as methyl ethyl ketone, acetone, or cyclohexane), ethers (such as diethyl ether or tetrahydrofuran), hydrocarbons (such as toluene, benzene, or cyclohexane), esters (such as ethyl acetate, butyl acetate, methyl acetate, or alkylcarboxylic acid ester), halogenated hydrocarbons (such as chlorobenzene, or dichloromethane), water, and ammonia. When water or ammonia is used as an entrainer, neither water nor ammonia is used as a supercritical fluid or subcritical fluid.

In the following, a control process involving a developing agent material feeding system after pressure reduction is described.

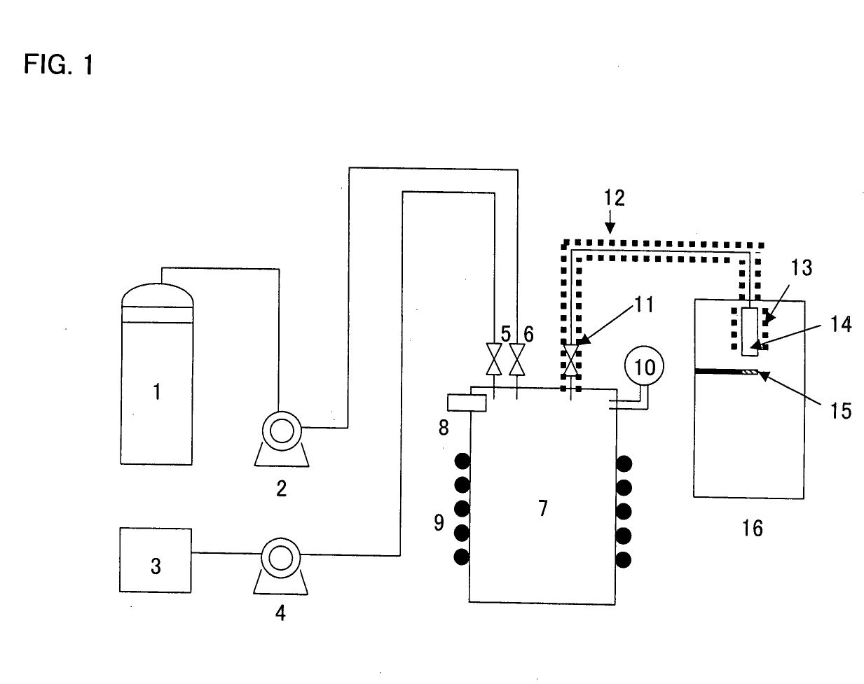

An example of the aforementioned operating process according to the invention is described. FIG. 1 shows a system that can be used as an apparatus for manufacturing a developing agent according to the invention. A gas tank 1 is filled with a substance to be used as a supercritical fluid. Gas is fed from the gas tank 1 to a reaction vessel 7, the pressure of the gas being increased to a desired level by a pressure pump 2. The pressure of an entrainer 3 is also increased to a desired level by a pressure pump 4. When the high-pressure gas and entrainer 3 are sent to the reaction vessel 7 via valves 5 and 6, the temperature of the high-pressure gas may be adjusted to near a desired temperature using a pre-heating coil or the like, which is not shown. Further alternatively, the supercritical gas and entrainer 3 may be mixed in a separated vessel (not shown) prior to being introduced into the reaction vessel 7.

A binder resin component and a colorant component as the materials for a developing agent are sealed inside the reaction vessel 7. The reaction vessel 7 is fitted with a heater 9, or may be fitted with a constant-temperature bath, which is not shown, whereby its temperature can be controlled to a desired level. The inside of the reaction vessel 7 is controlled by the valves 5 and 6 to have a desired pressure level. The temperature and pressure are monitored by a thermometer 8 and a pressure meter 10.

Thus, the supercritical fluid in a supercritical state, entrainer, binder resin component, and colorant component are mixed in the reaction vessel 7. The inside of the reaction vessel 7 may be stirred by a stirrer (such as a propeller-type stirrer, for example), which is not shown, as necessary.

Temperatures of the high-pressure gas in a connection mechanism from the reaction vessel 7 through to a nozzle 14, and the nozzle 14 itself, can be controlled to near desired levels using a pre-heating coil or the like. Further, a thermometer may be also installed at near the exit of the nozzle 14 to monitor the temperature there.

While maintaining the condition described above, when a depressurizing valve 11 shown in FIG. 1 is opened, the supercritical fluid inside the reaction vessel 7 is rapidly expanded. At the same time, the solubility of the individual solutes dissolved in the supercritical fluid significantly decreases, resulting in the deposition of each solute in the form of fine particles.

In this step, by appropriately adjusting the affinity between the colorant component and the binder resin component, and the affinity between the entrainer and the supercritical fluid, as well as the pressure adjustment conditions for the reaction vessel 7, developing-agent fine particles can be further obtained from the binder resin component that has been deposited in the form of fine particles in which the colorant component is buried in a substantially evenly distributed manner. These developing-agent particles, which are collected in a particle capturing box 16 via the nozzle 14, have a weight-average particle diameter of 3 to 7 μm.

Optionally, silica or other fine powder may be externally added to the obtained developing agent so as to adjust its liquidity or the like as necessary, using a known method (such as with a dry-type mixer), before obtaining a final developing agent.

In the following, various embodiments and their actions or effects are described in association with the attached claims.

Claim 1

A method for manufacturing a developing agent for electrostatic charge development, comprising dissolving a binder resin component in a supercritical fluid or subcritical fluid, mixing it with a colorant component, reducing the solubility of said binder resin component in said supercritical fluid or said subcritical fluid, and causing said binder resin component to be deposited in the form of particles while said colorant component is dispersed inside said binder resin component, wherein the pressure inside a reaction vessel is reduced from A (MPa) to B (MPa) (A>B>critical pressure) and then the pressure inside a reaction vessel is again increased up to near A (MPa) by adding a supercritical fluid when at least a developing agent material and a supercritical fluid or subcritical fluid are injected into said reaction vessel under high pressure.

Under the critical point, the resin does not easily dissolve or soften, resulting in large amounts of coarse particles. Further, if the supercritical fluid is the sole component that is fed, the concentration and composition ratio in the reaction vessel would vary as particles are deposited, resulting in a wider particle size distribution. By adopting the features of the present claim, the following actions or effects can be obtained. Namely, the feeding of developing agent materials in a supercritical fluid or subcritical fluid makes it possible to produce a developing agent with a narrow particle size distribution. It also allows for continuous production without having to open and close the reaction vessel, so that a highly efficient method for manufacturing a developing agent can be provided.

Claim 2

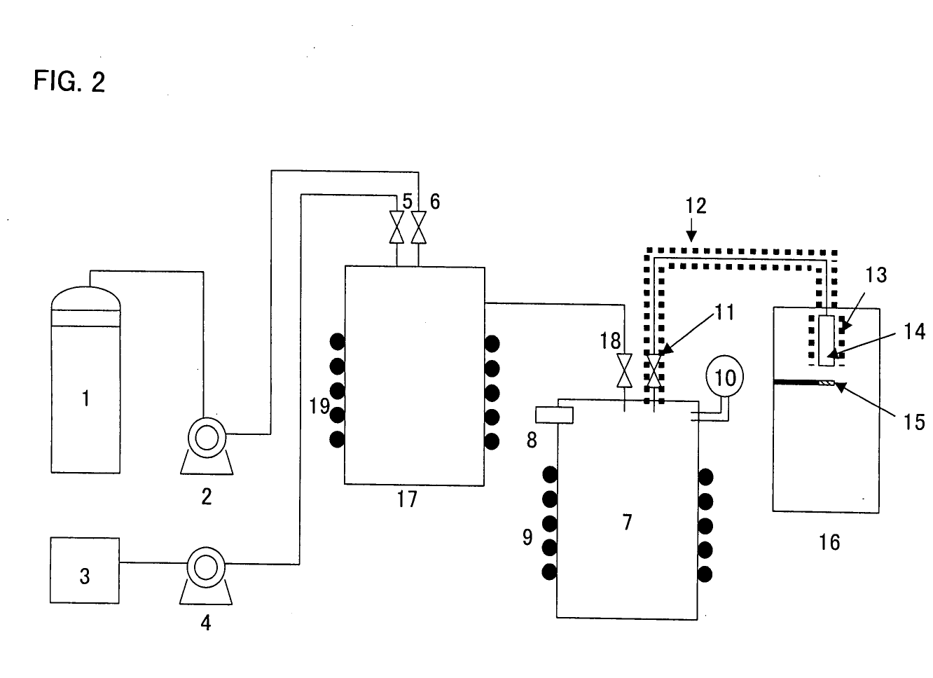

In this method for manufacturing a developing agent for electrostatic charge development, after the depressurization is terminated above the critical point, supercritical fluid or subcritical fluid is fed to a reaction vessel 7, as shown in FIG. 2, wherein the developing agent materials are dissolved in the supercritical fluid in a reaction vessel 17 beforehand. The developing agent materials and supercritical fluid are then fed via a valve 18 to the reaction vessel 17 where they are mixed.

When the developing agent materials are injected into the reaction vessel 7 under high pressure, clogging of valves tend to occur due to undissoloved components clinging to inlets or the like. In addition, if the undissolved components are put into the reaction vessel, this would extend the time necessary for dissolution and/or dispersion, thereby possibly decreasing production efficiency. By adopting the features of the present claim, the following actions or effects can be obtained. Namely, the feeding of undissoloved components of the developing agent materials can be prevented, and the rate of dissolution with respect to the supercritical fluid or subcritical fluid can be greatly increased. Thus, a highly efficient method for manufacturing a developing agent can be provided.

Claim 3

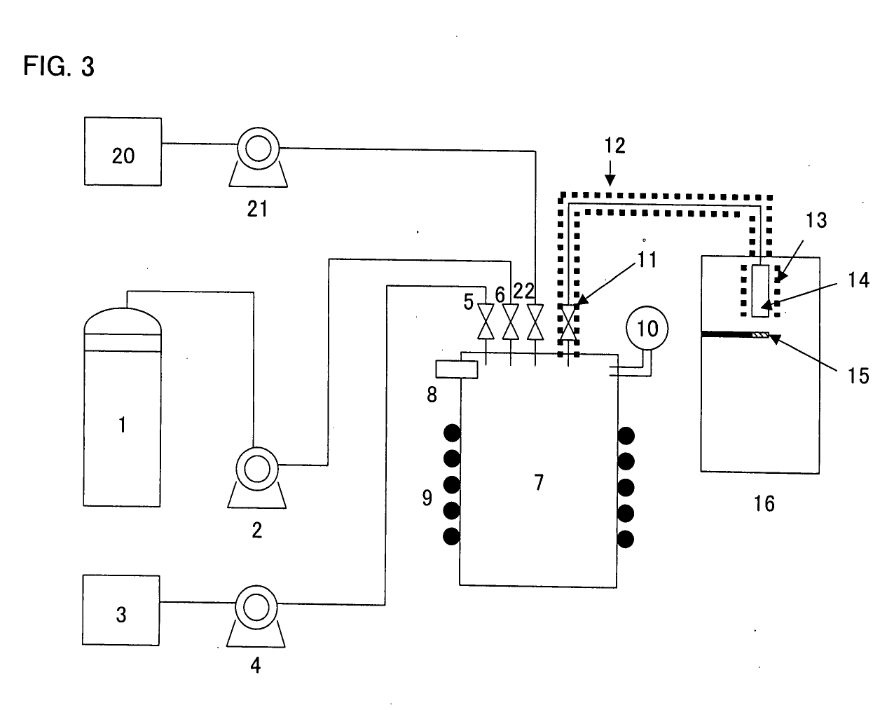

This is a method for manufacturing a developing agent for electrostatic charge development whereby, when a supercritical fluid or subcritical fluid is put into the reaction vessel 7 after depressurization is terminated above the critical point, developing agent materials are melted by heat in a reaction vessel 20 in advance and are then injected into the reaction vessel 7 under high pressure by means of a pressurizing pump 21, as shown in FIG. 3.

The time it takes for the developing agent materials to be dissolved in a supercritical fluid or subcritical fluid is one of the factors that can lower production efficiency. By adopting the features of the present claim, the following actions or effects can be obtained. Namely, the feeding of undissolved components of the developing agent materials can be prevented, and the rate of dissolution of the developing agent materials with respect to the supercritical fluid or subcritical fluid can be greatly increased. As a result, a highly efficient method for manufacturing a developing agent can be provided.

Claim 4

This is a method for manufacturing a developing agent for electrostatic charge development, whereby, when a supercritical fluid or subcritical fluid is again added into the reaction vessel 7 after depressurization is terminated above the critical point, an entrainer is also added.

The solubility of developing agent materials with respect to a supercritical fluid or subcritical fluid is low. By adopting the features of the present claim, the following action or effects can be obtained. Namely, the solubility of developing agent materials with respect to supercritical fluid or subcritical fluid can be greatly increased by adding entrainer 3 using a pressurizing pump 4. Thus, a highly efficient manufacturing method can be provided.

In the following, the invention is described by way of specific examples and comparative examples. It should be noted, however, that the invention is not limited to those embodiments.

### EXAMPLE OF MANUFACTURE OF DEVELOPING AGENT

FIG. 1 shows a developing agent manufacturing apparatus that can be used for the manufacture of a developing agent according to the invention. A reaction vessel 7 has a volume of 1000 cm³, for example. In the present example of manufacture, carbon dioxide is used as the gas to be used as a supercritical fluid. As an entrainer, generally commercially available ethanol is used.

Fifty grams of polyester resin (manufactured by Sanyo Chemical Industries Ltd., product name: EP208) as a binder resin component, and 20 parts by weight of carbon black (manufactured by Mitsubishi Chemical Corporation, product name: MA100) as a pigment relative to 100 parts by weight of the binder resin are put in the reaction vessel 7 in advance. Under normal temperature and pressure conditions, the aforementioned entrainer is incompatible with the binder resin component.

The carbon dioxide gas supplied from the gas tank 1 has its pressure increased by a pressurizing pump 2 and is introduced into the reaction vessel 7 via a valve 6. To the reaction vessel 7 is also introduced 200 ml of ethanol, or entrainer 3, via the pressurizing pump 4.

The depressurizing valve 11 for discharge purposes now remain closed, so that the pressure inside the reaction vessel 7 increases as the pressurized carbon dioxide is introduced therein. Temperature inside the reaction vessel 7, the temperature of an ejection mechanism, the temperature of the connection mechanism, and the temperature near the exit of the ejection mechanism are controlled by heaters 9, 12, and 13.

When the pressure inside the reaction vessel 7 reaches 7.3 (MPa), a supercritical state develops inside the reaction vessel 7. The critical temperature of carbon dioxide is 304.6K, and a supercritical state can be obtained by setting the temperature above the critical temperature.

This state is maintained for 20 minutes, for example, and then the depressurizing valve 11 is opened, whereby the mixture solution in the reaction vessel 7 is discharged via the nozzle 14 into the particle capturing box 16. The thus discharged solution is rapidly expanded, whereby developing agent fine particles can be captured in the particle capturing box 16 that comprise substantially spherically deposited binder resin component in which pigment is substantially evenly dispersed.

The carbon dioxide as the supercritical fluid and ethanol as the entrainer contained in the mixture solution are separated into carbon dioxide and ethanol in a collection mechanism (not shown) and individually reused.

In the present example of manufacture, because the entrainer used is not compatible with the binder resin component under normal temperature and pressure conditions, the individual developing agent fine particles do not bind to each other even if a minute amount of entrainer is attached to the surface of the resultant developing agent fine particles. Thus, the developing agent fine particles can be obtained in a fine state. Thereafter, 0.1 parts by weight of silica (manufactured by Nippon Aerosil Co., Ltd., product name: R742) is externally added by a known method (such as with a dry-type mixer) for controlling liquidity or the like, thereby obtaining a final developing agent.

### Example 1

When the pressure inside the reaction vessel 7 is 7.3 (MPa) or higher, a supercritical state develops inside the reaction vessel 7. In the present example, the valves 5 and 6 are adjusted to set the pressure inside the reaction vessel 7 to be 20 (MPa) so that at least the binder resin component inside the reaction vessel 7 is dissolved.

After the pressure inside the reaction vessel was reduced from 20 (MPa) to 15 (MPa) (A>B>critical pressure), carbon dioxide was again added. When the pressure inside the reaction vessel was increased to near 20 (MPa), 10 g of a polyester resin (manufactured by Sanyo Chemical Industries Ltd., product name: EP208) as a binder resin component, and 20 parts by weight of carbon black (manufactured by Mitsubishi Chemical Corporation, product name: MA100) as a pigment relative to 100 parts by weight of the binder resin were injected into the reaction vessel 7 under high pressure.

### Example 2

When the pressure inside the reaction vessel 7 is 7.3 (MPa) or higher, a supercritical state develops inside the reaction vessel 7. In the present example, the valves 5 and 6 are adjusted to set the pressure inside the reaction vessel 7 to be 20 (MPa) so that at least the binder resin component inside the reaction vessel 7 is dissolved.

After the pressure inside the reaction vessel was reduced from 20 (MPa) to 15 (MPa) (A, B>critical pressure), carbon dioxide was again added. When the pressure inside the reaction vessel was increased to near 20 (MPa), 10 g of a polyester resin (manufactured by Sanyo Chemical Industries Ltd., product name: EP208) as a binder resin component, and 10 parts by weight of carbon black (manufactured by Mitsubishi Chemical Corporation, product name: MA100) as a pigment relative to 100 parts by weight of the binder resin were injected into the reaction vessel 7 under high pressure.

### Example 3

When the pressure inside the reaction vessel 7 is 7.3 (MPa) or higher, a supercritical state develops inside the reaction vessel 7. In the present example, the valves 5 and 6 are adjusted to set the pressure inside the reaction vessel 7 to be 20 (MPa) so that at least the binder resin component inside the reaction vessel 7 is dissolved.

After the pressure inside the reaction vessel was reduced from 20 (MPa) to 15 (MPa) (A, B>critical pressure), carbon dioxide was again added. When the pressure inside the reaction vessel was increased to near 20 (MPa), 10 g of a polyester resin (manufactured by Sanyo Chemical Industries Ltd., product name: EP208) as a binder resin component, and 30 parts by weight of carbon black (manufactured by Mitsubishi Chemical Corporation, product name: MA100) as a pigment relative to 100 parts by weight of the binder resin were injected into the reaction vessel 7 under high pressure.

### Example 4

The same procedure as described with reference to the above examples of manufacturing a developing agent was performed except that, with reference to FIG. 2, when putting a supercritical fluid or subcritical fluid into the reaction vessel 7 again, 10 g of polyester resin (manufactured by Sanyo Chemical Industries Ltd., product name: EP208) as a binder resin component, and 20 parts by weight of carbon black (manufactured by Mitsubishi Chemical Corporation, product name: MA100) as a pigment relative to 100 parts by weight of the binder resin had been dissolved in another reaction vessel 17 in advance in a supercritical state where the pressure was set to be 25 (MPa), and then they were fed via a valve 18 to the reaction vessel 7 where they were mixed.

The resultant developing agent had a high pigment content and good pigment dispersibility. It was capable of producing desired print densities even at small quantities, and the amount of developing agent required for producing a predetermined number of printouts was a fraction of what it normally takes when a conventional developing agent is used (with a known melting, kneading, and pulverizing process, for example). Thus, a handy and small-sized image forming apparatus can be provided without reducing the intervals of replacement of the developing agent.

When a developing agent was prepared by a conventional method (such as the known melting, kneading, and pulverizing method, for example) where a high concentration of pigment was contained, as in Example 4, it was necessary to perform classification so as to obtain a sharp particle size distribution. In this case, the transfer efficiency was also poor due to shape irregularities. In contrast, in the developing agent of the invention, such problems can be avoided and good images can be obtained stably.

### Example 5

The same procedure as described with reference to the above examples of manufacturing a developing agent was performed except that, with reference to FIG. 3, when putting a supercritical fluid or subcritical fluid into the reaction vessel again, 10 g of polyester resin (manufactured by Sanyo Chemical Industries Ltd., product name: EP208) as a binder resin component, and 20 parts by weight of carbon black (manufactured by Mitsubishi Chemical Corporation, product name: MA100) as a pigment relative to 100 parts by weight of the binder resin had been melted by heating to 200° C. in another reaction vessel 20 in advance, before they were injected into the reaction vessel 7 under high pressure using a pressurizing pump 21.

### Example 6

The same procedure as described in the Example of Manufacture of Developing Agent was performed except that, as shown in FIG. 3, 25 ml of ethanol as entrainer 3 was added when putting the supercritical fluid or subcritical fluid into the reaction vessel 7 again.

Yield and Evaluation of Developing Agents

Regarding the developing agents prepared in Examples 1 to 6, after the above-described series of steps were repeated 20 times, the yield with respect to the amount of resin put into the reaction vessel was determined.

Ferrite carrier with an average particle diameter of 80 μm was mixed with 100 parts by weight each of the developing agents prepared in Examples 1 to 6, thereby preparing a two-component developing agent with a developing agent concentration of 4%. The obtained developing agent was used on an electrophotographic copy machine (AR-450M manufactured by Sharp Corporation) for making 10,000 copies of a manuscript with an initial and manuscript density of 6% in a continuous manner. Thereafter, 50 mm×50 mm solid images were produced and then the density of its image and non-image portions were measured using a densitometer (RD-918 manufactured by Macbeth). The initial developing agent and the developing agent after 10,000 continuous copies were sampled from the developer within the electrophotographic copy machine, and their charge amounts were measured by the blowoff method. Charge stability refers to the ratio of change of the initial charge amount and the charge amount after 10,000 copies.

Image density was evaluated in three levels by rating image densities of 1.4 or greater as very good, 1.2 to 1.4 as good, and 1.2 or smaller as poor.

Fog was also evaluated in three levels by rating fog values of 0.8 or smaller very good, 0.8 to 1.2 as good, and 1.2 or greater as poor.

Charge stability was also evaluated in three levels in terms of the ratio of the charge amount after 10,000 copies to the initial charge amount. Specifically, the ratio of 80 to 100% was rated as very good, 60 to 80% as good, and 60% or less as poor.

Yield and image quality relative to different methods for manufacturing developing agent are summarized in Tables 1 and 2 below.

TABLE 1
Yield and image quality relative to methods for manufacturing
developing agent

| | | Image density | | Fog | | | | |
|---|---|---|---|---|---|---|---|---|
| | | | 10,000 | | 10,000 | | | Overall |
| Exam- | Yield | | copies | | copies | Charge | | evalua- |
| ple | (%) | Initial | later | Initial | later | stability | | tion |
| 1 | 42 | Very | Good | Very | Poor | Very | Poor | Good |
| | | good | | good | | good | | |
| 2 | 40 | Very | Poor | Very | Good | Very | Poor | Good |
| | | good | | good | | good | | |
| 3 | 41 | Very | Good | Very | Poor | Very | Poor | Good |
| | | good | | good | | good | | |

TABLE 2
Yield and image quality relative to methods for manufacturing
developing agent

| | | Image density | | Fog | | | | |
|---|---|---|---|---|---|---|---|---|
| | | | 10,000 | | 10,000 | | | Overall |
| Exam- | Yield | | copies | | copies | Charge | | evalua- |
| ple | (%) | Initial | later | Initial | later | stability | | tion |
| 1 | 42 | Very | Good | Very | Poor | Very | Poor | Good |
| | | good | | good | | good | | |
| 4 | 51 | Very | Good | Very | Poor | Very | Good | Good |
| | | good | | good | | good | | |
| 5 | 57 | Very | Good | Very | Good | Very | Good | Good |
| | | good | | good | | good | | |
| 6 | 65 | Very | Very | Very | Very | Very | Very | Very |
| | | good | good | good | good | good | good | good |

It will be seen from Table 1 that equivalent image quality can be obtained for examples with higher pigment content. It will also be seen from Table 2 that the fog and charge stability values can be improved by increasing dispersibility by dissolving the toner materials in advance before feeding them.

### INDUSTRIAL APPLICABILITY

In accordance with the invention, the dispersibility of the colorant in the developing agent is increased up to a primary particle level, whereby a developing agent with an even particle shape and a narrow particle size distribution can be obtained. Furthermore, a method for manufacturing a developing agent can be obtained whereby continuous production can be performed without opening and closing a reaction vessel, resulting in a high production efficiency.

1. A method for manufacturing a developing agent for electrostatic charge development, comprising dissolving a binder resin component in a supercritical fluid or subcritical fluid, mixing it with a colorant component, reducing the solubility of said binder resin component in said supercritical fluid or said subcritical fluid, and causing said binder resin component to be deposited in the form of particles while said colorant component is dispersed inside said binder resin component, said method further comprising reducing the pressure inside a reaction vessel from A (MPa) to B (MPa) (A>B>critical pressure) after a developing agent has been produced, and then, when proceeding back to the developing agent manufacturing process again, at least a developing agent material and a supercritical fluid or subcritical fluid are injected into said reaction vessel under high pressure.

2. The method for manufacturing a developing agent for electrostatic charge development according to claim 1, further comprising, when proceeding back to said developing agent manufacturing process again, said developing agent material is dissolved in the supercritical fluid in advance before it is injected into a high-pressure cell.

3. The method for manufacturing a developing agent for electrostatic charge development according to claim 1, further comprising, when proceeding back to said developing agent manufacturing process again, said developing agent material is melted by heat before it is injected into a high-pressure cell.

4. The method for manufacturing a developing agent for electrostatic charge development according to claim 1, comprising adding an entrainer when proceeding back to said developing agent manufacturing process.

5. A developing agent for electrostatic charge development prepared by the manufacturing method according to claim 1.

6. The method for manufacturing a developing agent for electrostatic charge development according to claim 2, comprising adding an entrainer when proceeding back to said developing agent manufacturing process.

7. The method for manufacturing a developing agent for electrostatic charge development according to claim 3, comprising adding an entrainer when proceeding back to said developing agent manufacturing process.

8. A developing agent for electrostatic charge development prepared by the manufacturing method according to claim 2.

9. A developing agent for electrostatic charge development prepared by the manufacturing method according to claim 3.

10. A developing agent for electrostatic charge development prepared by the manufacturing method according to claim 4.
